(19) United States
(12) Patent Application Publication
(10) Pub. No.: US 2024/0397245 A1
(43) Pub. Date: Nov. 28, 2024

(54) Multiple-Device Bluetooth

(71) Applicant: Joshua Henry, Clearfield, PA (US)

(72) Inventor: Joshua Henry, Clearfield, PA (US)

(21) Appl. No.: 18/200,049

(22) Filed: May 22, 2023

(51) Int. Cl. H04R 1/02

(52) U.S. Cl. CPC H04R 1/02

(57) ABSTRACT

The Ultimate Shuffle is the only product of its kind that introduces a speaker possessing multiple Bluetooth connections to ensure users are able to seamlessly shuffle through connected devices, playing music randomly, to help provide a balance for everyone's favorite songs to be in rotation at a gathering and/or event. This unprecedented device is uniquely designed with a cutting-edge sound quality system and multiple USB ports to enable users to connect their devices either via primary cording or Bluetooth connection.

### BACKGROUND

In large group settings, it can be difficult to please each and every person when it comes to identifying a range of music to enjoy. Individuals will often have to take turns switching out their devices in order to play their favorite song on a speaker, which can be inconvenient and frustrating in real-time just to support a diversity of tunes. There have been no products available as original equipment or as an aftermarket to address this problem.

An apparatus to simplify the ability to play a variety of music from more than one user's playlist is not being met by any known device or system at present. There have been no products available as original equipment or as an aftermarket to address this problem either.

### SUMMARY OF THE INVENTION

The main purpose of the multiple-device Bluetooth is to provide users with a method of connecting multiple devices to a primary speaker whereas the speaker can play from a selection of music, from either device, randomly.

An audio speaker system including an audio speaker, multiple input channels configured to drive the speaker, a multiplexor circuit configured to select one of the plurality of input channels to drive the speaker at a given time, and a queue configured to hold audio files to be played on the audio speaker for each of the plurality of input channels.

### BRIEF DESCRIPTION OF THE DRAWINGS

FIG. 1 is a front perspective view of the multiple input device audio speaker in accordance with an embodiment of the present disclosure.

FIG. 2 is a back perspective view of the multiple input channel device audio speaker in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one, skilled in the relevant art and having possession of this disclosure, are to be considered within the scope of the invention.

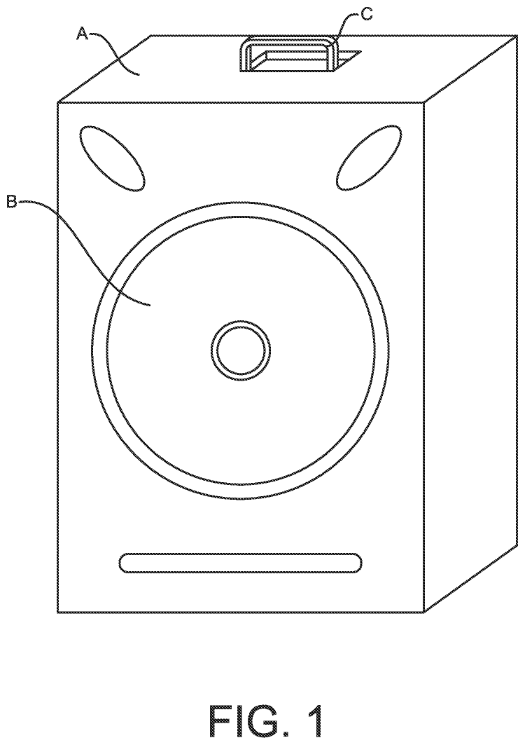

FIG. 1 is a front perspective view of the multiple-channel audio speaker with multiple connection and shuffle features referenced as A, sound system referenced as B, folding handle referenced as C, in accordance with an embodiment of the present disclosure.

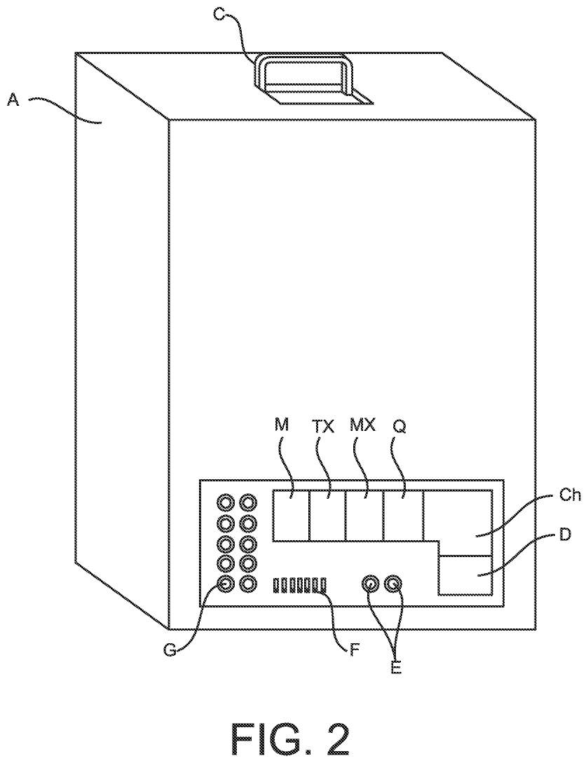

FIG. 2 is a back perspective view of the multiple-channel audio speaker with multiple connection and shuffle features referenced as A, folding handle referenced as C, host display for devices referenced as D, in/out AUX referenced as E, USB ports referenced as F, cable ports referenced as G, in accordance with an embodiment of the present disclosure. The back perspective view also illustrates the transceiver circuits TX, the multiplexor circuit MX and the queue Q. The transceiver circuits TX receive the multiple and simultaneous input channels Ch and the queue Q input and control wireless through Bluetooth and other short communications protocol. The multiple input channels Ch are also received via hardware on the audio speaker A including but not limited to the cable ports G, the usb ports F, the auxiliary ports E etc. The multiplexor circuit, MX also known as an audio mux selects an audio file to drive to the audio speaker A for playing. An audio mixer M is also included in embodiments to bypass the audio mux MX and play multiple audio files simultaneously on the audio speaker A. The multiple input channels Ch are received wirelessly and via hardware on the audio speaker and system as disclosed herein.

The present disclosed multiple-device Bluetooth, also known as “Ultimate Shuffle”, offers a modern speaker alternative that ensures multiple people are able to listen to what they like as it permits a multi-connection to devices and therefore can play any selection from a device that it is paired with, simultaneously. Expanding on the initial design of an average speaker, the Ultimate Shuffle introduces a novel speaker with the capability of maintaining a connection to multiple devices at once. The desired connections have been established through a host box via Bluetooth or the USB cords, with advanced technology, the speaker will shuffle through each device and play songs from each specific database or queue, randomly. Unlike any other speaker available in the market, this innovative top-quality product guarantees all individuals are satisfied with the music playing, and eliminates the need for individuals to manually switch out their devices or browse through various playlists to find the songs they seek to play.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. An audio speaker system comprising:
an audio speaker;
a plurality of input channels configured to drive the speaker;
a multiplexor circuit configured to select one of the plurality of input channels to drive the speaker at a given time; and
a queue configured to hold audio files to be played on the audio speaker for each of the plurality of input channels.

2. The audio speaker system of claim 1, wherein the audio files comprise music play lists.

3. The audio speaker system of claim 1, further comprising a plurality of physical port connections on the audio speaker corresponding to the plurality of input channels.

4. The audio speaker system of claim 1, further comprising a plurality of auxiliary ports on the audio speaker configured as input channels.

5. The audio speaker system of claim 1, further comprising a plurality of USB (Universal Serial Bus) ports on the audio speaker configured as input channels.

6. The audio speaker system of claim 1, further comprising a plurality of cable ports on the audio speaker configured as input channels.

7. The audio speaker system of claim 1, further comprising a host screen configured to display the queue and a status of the audio files.

8. The audio speaker system of claim 1, further comprising a logic circuit configured to drive an audio file through the multiplexor circuit based on a predetermined criteria.

9. The audio speaker system of claim 8, wherein the predetermined criteria is a random generator selection of the audio files.

10. The audio speaker system of claim 8, wherein the predetermined criteria is a shuffle of the audio files.

11. The audio speaker system of claim 1, further comprising a wireless transceiver circuit configured to electronically handshake with the queue.

12. The audio speaker system of claim 1, wherein each of the plurality of input channels are received via a wireless transceiver circuit.

13. The audio speaker system of claim 1, further comprising a mixer circuit configured to bypass the multiplexor circuit and enable a plurality of audio files to play simultaneously on the audio speaker.

14. The audio speaker system of claim 1, further comprising a plurality of audio speakers configured to share the queue and the multiplexor circuit.

15. The audio speaker system of claim 1, further comprising a plurality of audio speakers configured each with a separate queue and a separate multiplexor circuit.

16. The audio speaker system of claim 1, wherein the audio speaker is a handheld portable speaker.

17. The audio speaker system of claim 1, wherein the audio speaker is commercial multiple thousand watt speaker.

18. The audio speaker system of claim 1, wherein each of the plurality of input channels corresponds with a cell phone communications paired with a specific input channel.
